(19) United States
(12) Patent Application Publication
(10) Pub. No.: US 2013/0321690 A1
(43) Pub. Date: Dec. 5, 2013

(54) Methods and Apparatus for Refocusing via Video Capture

(71) Applicants: Aravind Krishnaswamy, San Jose, CA (US); Radomir Mech, Mountain View, CA (US)

(72) Inventors: Aravind Krishnaswamy, San Jose, CA (US); Radomir Mech, Mountain View, CA (US)

(21) Appl. No.: 13/485,542

(22) Filed: May 31, 2012

(51) Int. Cl. G03B 13/32

(52) U.S. Cl. 348/345; 348/E05.045

(57) ABSTRACT

Methods and apparatus for refocusing via video capture are disclosed. In response to an image capture request, a multi-focus image data structure including a plurality of image data structures representing a scene is captured. The capturing the plurality of image data structures further includes capturing a first image data structure, altering a focal distance of a lens apparatus focusing light on a photosensor, and capturing a second image data structure.

### BACKGROUND

### Description of the Related Art

A light-field camera, also called a plenoptic camera, is a camera that uses a microlens array to capture 4D light field information about a scene. Such light field information can be used to improve the solution of computer graphics and vision-related problems. In currently-available light-field cameras, an array of microlenses is placed at the focal plane of the camera main lens. Am image sensor is positioned slightly behind the microlenses. Using such images the displacement of image parts that are not in focus can be analyzed and depth information can be extracted. Potentially, this camera system can be used to refocus an image virtually on a computer after the picture has been taken.

Unfortunately, currently-available light-field cameras represent a significant investment in expensive and sophisticated hardware. One example is a prototype 100-megapixel camera that takes a three-dimensional photo of the scene in focus using 19 uniquely configured lenses. Each lens takes a 5.2 megapixel photo of the entire scene around the camera and each image can be focused later in any way. Such a camera, with its complex manufacturing, is beyond the reach of casual users.

### SUMMARY

Methods and apparatus for refocusing via video capture are disclosed. In response to an image capture request, a multi-focus image data structure including a plurality of image data structures representing a scene is captured. The capturing the plurality of image data structures further includes capturing a first image data structure, altering a focal distance of a lens apparatus focusing light on a photosensor, and capturing a second image data structure.

### BRIEF DESCRIPTION OF THE DRAWINGS

FIG. 1 is a schematic diagram of an image data capture system that may be used in some embodiments.

FIG. 2 illustrates a module that may implement refocusing via video capture, according to some embodiments.

FIG. 3 depicts lens apparatus movements that may be executed to implement refocusing via video capture, according to some embodiments.

FIG. 4 is a high-level logical flowchart of operations that may be used to implement refocusing via video capture according to some embodiments.

FIG. 5 is a high-level logical flowchart of operations that may be used to implement refocusing via video capture according to some embodiments.

FIG. 6 is a high-level logical flowchart of operations that may be used to implement refocusing via video capture according to some embodiments.

FIG. 7 is a high-level logical flowchart of operations that may be used to implement refocusing via video capture according to some embodiments.

FIG. 8 is a high-level logical flowchart of operations that may be used to implement refocusing via video capture according to some embodiments.

FIG. 9 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated.

It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Various embodiments of methods and apparatus for refocusing via video capture are disclosed. Some embodiments include a method for refocusing via video capture using one or more processors to perform, in response to an image capture request, capturing a multi-focus image data structure including a plurality of image data structures representing a scene. The capturing the plurality of image data structures further includes capturing a first image data structure, altering a focal distance of a lens apparatus focusing light on a photosensor, and capturing a second image data structure. In some embodiments, each of the image data structures of the multi-focus image data structure is approximately centered on a single common center point of the common scene, such that any particular portion of the common scene is captured in multiple image data structures of the multi-focus image data structure at sequential times in differing focal lengths. In some embodiments, for any given common portion of the scene, multiple image data structures of the multi-focus image data structure are available for the common scene at varying focal lengths, and each image data structure portrays the substantial entirety of the common scene at a single given focal length.

While embodiments are discussed herein with respect to capturing a first image data structure and a second structure, one of skill in the art will understand in light of having read the present disclosure that the invention is not so limited. Embodiments vary in terms of the number of image data structures that are captured, with the number of image data structures captured varying between from two to ‘n’ in various embodiments to suit the needs of particular users and the capabilities of particular hardware and software. In some embodiments, image data structures are continuously captured and refocusing is performed while capture is in progress. More specifically, in some embodiments, refocusing is stopped during image data structure capture. In other embodiments, refocusing continues while image data structures are captured. In some embodiments, the method includes generating an image of the scene by interpolating the image of the scene from a plurality of image data structures, wherein the generating further includes generating an image of the scene with a focal distance different from the focal distances of the image data structures.

In some embodiments, the method further includes generating an image of the scene by compositing the image of the scene from a plurality of image data structures. In some such embodiments, the generating the image of the scene by compositing the image of the scene from the plurality of image data structures further includes generating an image of the scene including regions having respective regional focal distances different from one another. In some embodiments, the altering the focal distance of the lens apparatus focusing the light on the photosensor further includes moving the lens apparatus focusing the light on the photosensor from a first position to a second position, and stopping movement of the lens apparatus focusing the light on the photosensor before beginning capturing the second image data structure. In some embodiments, the second distance is greater than the first distance. In some embodiments, the stopping the movement of the lens apparatus focusing the light on the photosensor before beginning capturing the second image data structure further includes stopping the movement of the lens apparatus focusing the light on the photosensor for an interval more than 1.5 times greater than but less than 2.5 times greater than the shutter interval.

In some embodiments, the altering a focal distance of the lens apparatus focusing light on the photosensor further includes moving the lens apparatus focusing light on the photosensor a first distance, and the method further includes, after capturing the second image data structure, moving the lens apparatus focusing light on the photosensor a second distance and capturing a third image data structure. In some such embodiments, the first distance and the second distance are not equal.

Some embodiments include means for refocusing via video capture. For example, a video capture module includes program instructions executable by at least one processor to, in response to an image capture request, capture a multi-focus image data structure including a plurality of image data structures representing a scene. In some embodiments the program instructions executable by the at least one processor to capture the plurality of image data structures further include program instructions executable by the at least one processor to capture a first image data structure, alter a focal distance of a lens apparatus focusing light on a photosensor, and capture a second image data structure.

In some embodiments, the module further includes program instructions executable by the at least one processor to generate an image of the scene by interpolating the image of the scene from a plurality of image data structures. In some embodiments, the program instructions executable by the at least one processor to generate further include program instructions executable by the at least one processor to generate an image of the scene with a focal distance different from the focal distances of the image data structures.

In some embodiments, the module further includes program instructions executable by the at least one processor to generate an image of the scene by compositing the image of the scene from a plurality of image data structures. In some such embodiments, the program instructions executable by the at least one processor to generate further include program instructions executable by the at least one processor to generate an image of the scene including regions having respective regional focal distances different from one another.

In some embodiments, the program instructions executable by the at least one processor to alter the focal distance of the lens apparatus focusing the light on the photosensor further include program instructions executable by the at least one processor to move the lens apparatus focusing the light on the photosensor from a first position to a second position and stop movement of the lens apparatus focusing the light on the photosensor before beginning capturing the second image data structure. In some embodiments, the program instructions executable by the at least one processor to stop the movement of the lens apparatus focusing the light on the photosensor before beginning capturing the second image data structure further include program instructions executable by the at least one processor to stop the movement of the lens apparatus focusing the light on the photosensor for an interval more than 1.5 times greater than but less than 2.5 times greater than the shutter interval.

In some embodiments, the program instructions executable by the at least one processor to alter a focal distance of the lens apparatus focusing light on the photosensor further include program instructions executable by the at least one processor to move the lens apparatus focusing light on the photosensor a first distance, and the program instructions executable by the at least one processor further comprise program instructions executable by the at least one processor to after capturing the second image data structure, move the lens apparatus focusing light on the photosensor a second distance, and capture a third image data structure. In some such embodiments, the first distance and the second distance are not equal. In some embodiments, the second distance is greater than the first distance.

The video capture module may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to implement, in response to an image capture request, capturing a multi-focus image data structure including a plurality of image data structures representing a scene. In some embodiments, the capturing the plurality of image data structures further includes capturing a first image data structure, altering a focal distance of a lens apparatus focusing light on a photosensor, and capturing a second image data structure.

In some embodiments, the non-transitory computer-readable storage medium further includes program instructions computer-executable to implement generating an image of the scene by interpolating the image of the scene from a plurality of image data structures. In some embodiments, the program instructions computer-executable to implement the generating further include program instructions computer-executable to implement generating an image of the scene with a focal distance different from the focal distances of the image data structures.

In some embodiments, the non-transitory computer-readable storage medium further includes program instructions computer-executable to implement generating an image of the scene by compositing the image of the scene from a plurality of image data structures. The program instructions computer-executable to implement the generating further include program instructions computer-executable to implement generating an image of the scene including regions having respective regional focal distances different from one another.

In some embodiments, the program instructions computer-executable to implement the altering the focal distance of the lens apparatus focusing the light on the photosensor further include program instructions computer-executable to implement moving the lens apparatus focusing the light on the photosensor from a first position to a second position and stopping movement of the lens apparatus focusing the light on the photosensor before beginning capturing the second image data structure.

In some embodiments, the program instructions computer-executable to implement stopping the movement of the lens apparatus focusing the light on the photosensor before beginning capturing the second image data structure further include program instructions computer-executable to implement stopping the movement of the lens apparatus focusing the light on the photosensor for an interval more than 1.5 times greater than but less than 2.5 times greater than the shutter interval.

In some embodiments, the program instructions computer-executable to implement altering a focal distance of the lens apparatus focusing light on the photosensor further include program instructions computer-executable to implement moving the lens apparatus focusing light on the photosensor a first distance, and the non-transitory computer-readable storage medium further includes program instructions computer-executable to implement, after capturing the second image data structure, moving the lens apparatus focusing light on the photosensor a second distance, capturing a third image data structure. In some such embodiments, the first distance and the second distance are not equal. Other embodiments of the video capture module may be at least partially implemented by hardware circuitry and/or firmware stored, for example, in a non-volatile memory.

### Example Implementations

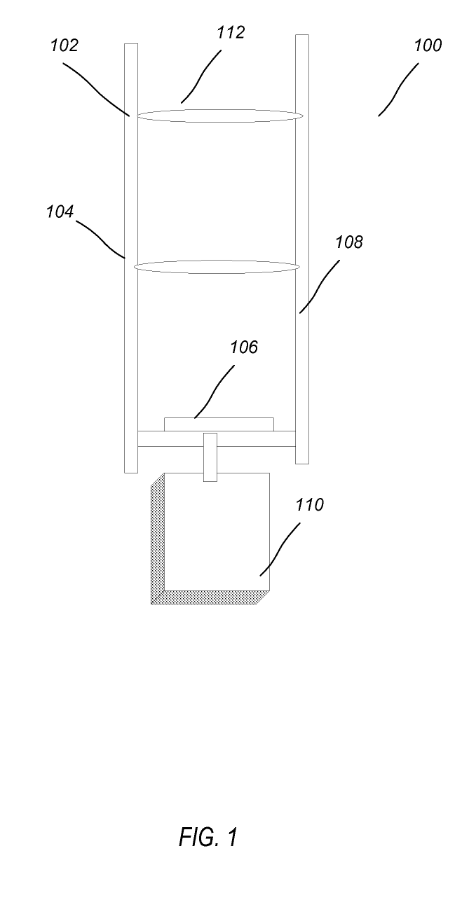

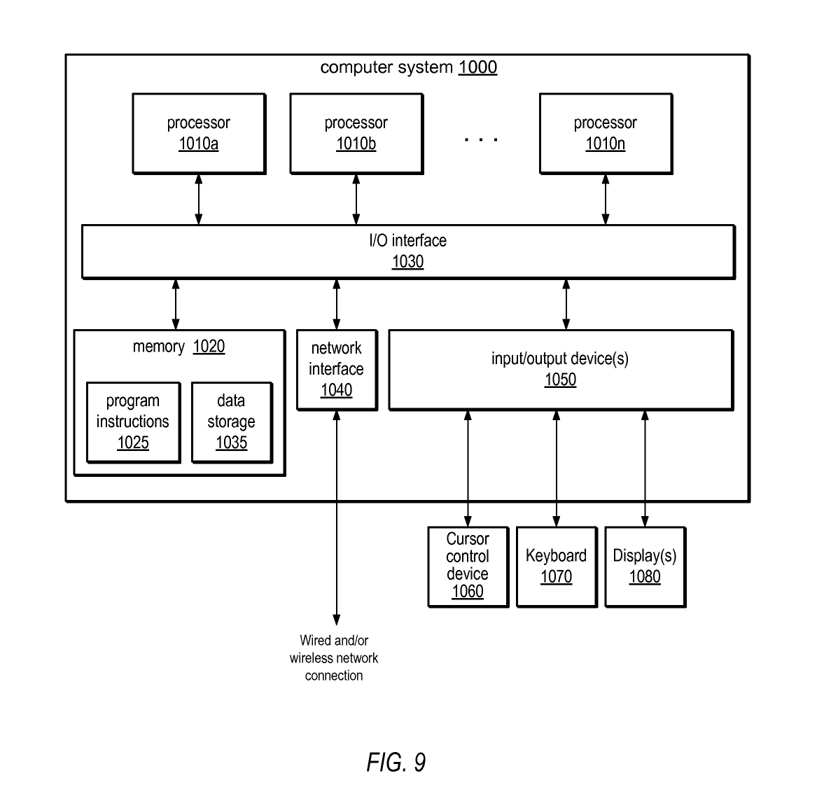

FIG. 1 is a schematic diagram of an image data capture system that may be used in some embodiments. A video capture system 100 includes a processor 110 connected to a photosensor 106 and a lens movement apparatus 108 for moving a lens apparatus 112 from a first position 102 to a second position 104. In some embodiments, lens apparatus 112 is a single lens that is moved by lens movement apparatus 108 relative to photosensor 106. In other embodiments, lens apparatus 112 is a set of multiple lenses that may move relative to one another in addition to or in substitution for moving relative to photosensor 106. Movement of lens apparatus 112 is used to change the focal distance of light captured by photosensor 106. In some embodiments, video capture system 100 is a full featured stand-alone camera, such as, by way of non-limiting example, a video camera. In other embodiments, video capture system 100 is special purpose hardware integrated into a computing system (e.g., a cell phone or tablet) and processor 110 is shared with other functions of the computing system (e.g., one or more of processors 1010a-1010n of computer system 1000 of FIG. 9).

Returning to FIG. 1, in some embodiments, in response to an image capture request, processor 110 captures a multi-focus image data structure including a plurality of image data structures from photosensor 106 representing a scene visible through lens apparatus 112. Processor 110 captures a first image data structure from photosensor 106, alters a focal distance of a lens apparatus 112 focusing light on photosensor 106 by moving lens apparatus 112 from the first position 102 to the second position 104, and captures a second image data structure from photosensor 106.

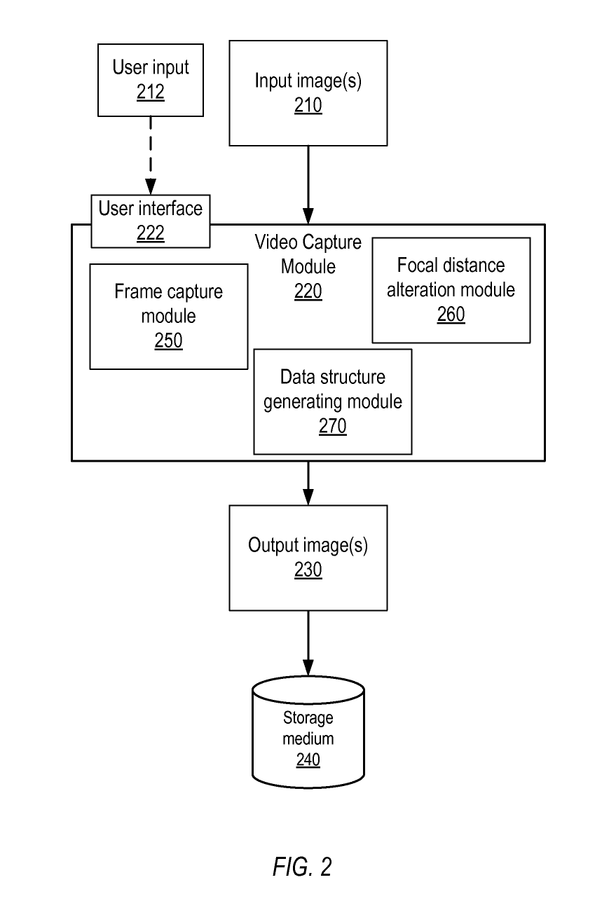

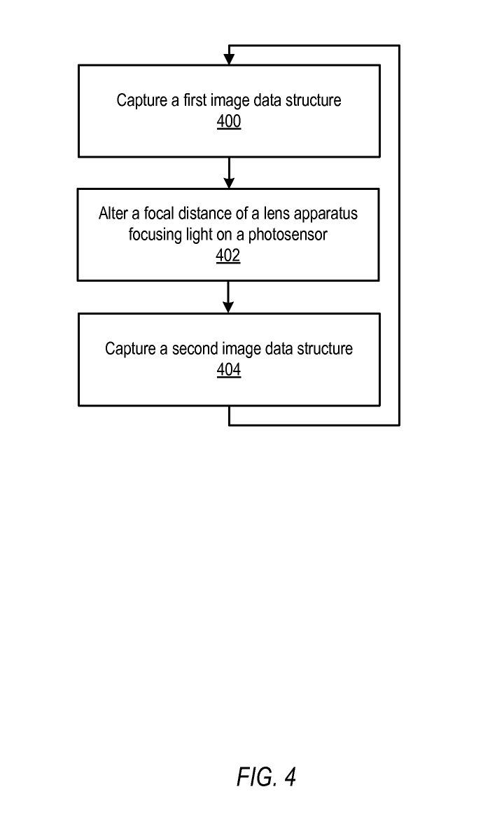

FIG. 2 illustrates a video capture module that may implement one or more of the refocusing via video capture techniques and tools illustrated in FIGS. 4 through 8. Video capture module 220 may, for example, provide one or more of a video capture-based multi-focus image data structure generating tool, a multi-focus image data extraction tool, and a multi-focus image data interpolation tool. FIG. 9 illustrates an example computer system on which embodiments of video capture module 220 may be implemented. Video capture module 220 receives as input one or more digital images 210. Examples of digital images 210 include image data structures captured from a photosensor (for example, photosensor 106 of FIG. 1). Video capture module 220 may receive user input 212 activating one or more of a video capture-based multi-focus image data structure generating tool, a multi-focus image data extraction tool, and a multi-focus image data interpolation tool.

In response to user input 212 activating a video capture-based multi-focus image data structure generating tool, video capture module 220 performs capturing a multi-focus image data structure including a plurality of image data structures representing a scene. In response to user input 212 activating a multi-focus image data extraction tool, video capture module 220 performs generating an image of the scene, which in some embodiments, includes extraction of the image of the scene from among the plurality of the imaged data structures. In response to user input 212 activating a multi-focus image data interpolation tool, video capture module 220 performs generating an image of the scene by interpolating the image of the scene from a plurality of image data structures, and the generating further includes generating an image of the scene with a focal distance different from the focal distances of the image data structures. Video capture module 220 generates as output one or more output images 230. Output images include but are not limited to both multi-focus image data structures and images of the scene generated from multi-focus image data structures. Output image(s) 230 may, for example, be stored to a storage medium 240, such as system memory, a disk drive, DVD, CD, etc.

In some embodiments, module 220 may provide a user interface 222 via which a user may interact with the module 220, for example to activate one or more of a video capture-based multi-focus image data structure generating tool, a multi-focus image data extraction tool, and a multi-focus image data interpolation tool, and to perform a method for refocusing via video capture as described herein. In some embodiments, the user interface may provide user interface elements whereby the user may select options including, but not limited to, focal length, areas for particular focal length, and/or blending.

In some embodiments, a focal distance alteration module 260 controls a motor apparatus to execute altering a focal distance of a lens apparatus focusing light on a photosensor. In some embodiments, a frame capture module 250 performs capturing a first image data structure and capturing a second image data structure. In some embodiments, a data structure generating module 270 performs capturing a multi-focus image data structure including a plurality of image data structures representing a scene.

In some embodiments, the data structure generating module 270 performs generating an image of the scene by interpolating the image of the scene from a plurality of image data structures, which sometimes includes generating an image of the scene with a focal distance different from the focal distances of the image data structures. In some embodiments, a data structure generating module 270 performs generating an image of the scene by compositing the image of the scene from a plurality of image data structures, which sometimes includes generating an image of the scene including regions having respective regional focal distances different from one another.

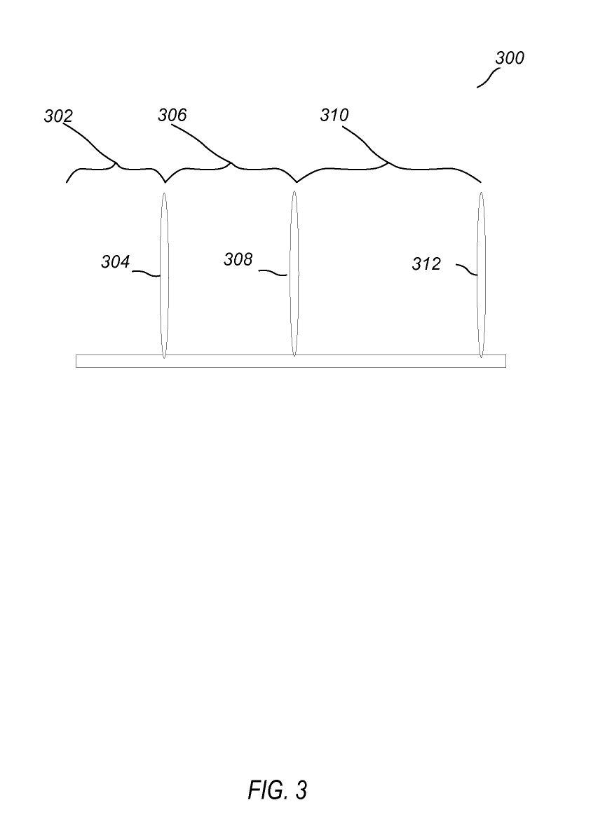

FIG. 3 depicts lens apparatus movements that may be executed to implement refocusing via video capture, according to some embodiments. A lens track 300 includes a lens apparatus at a first position 304 that is a base distance 302 from a photo sensor (not shown). The lens track 300 further includes the lens apparatus at a second position 308 that is a first distance 306 from the first position 304. The lens track 300 further includes the lens apparatus at a third position 312 that is a second distance 310 from the selected position 308. Thus, some embodiments move the focus to desired first value represented by first position 304 and start video capture to generate image data structures. In some embodiments, after 1 frame, the embodiment is moved across first distance 306 to second position 310. In some embodiments, image capture is performed continuously during movement across first distance 306 to second position 310. Some embodiments then stop and maintain a fixed focus at second position 310 for 1.5-2.5 frames in order to compensate for uncertainty with respect to exactly at what point of frame capture the focus movement stopped. For example, movement to second position 310 may have been completed in the middle of a frame. Some embodiments employ the interval of about 2 frames to assure that there will be one frame captured fully during the fixed focus at second position 310. Such embodiments then adjust focus across second distance 310 to third position 312. Some embodiments discard images captured during refocusing, but the invention is not so limited. Additionally, while FIG. 3 is described with respect to only three positions for the sake of simplicity and brevity in description, one of skill in the art will understand in light of having read the present disclosure that the invention is not so limited. Embodiments vary in terms of the number of image data structures that are captured, as well as the number of focal positions used, with the number of image data structures captured and focal positions used varying between from two to ‘n’ in various embodiments to suit the needs of particular users and the capabilities of particular hardware and software.

In some embodiments, capturing the plurality of image data structures includes capturing a first image data structure at first position 304, altering a focal distance of a lens apparatus focusing light on a photosensor through first distance 306, and capturing a second image data structure at second position 308. Some embodiments support moving the lens apparatus focusing the light on the photosensor from first position 304 to second position 306, and stopping movement of the lens apparatus focusing the light on the photosensor at second position 308 before beginning capturing the second image data structure.

In some embodiments the altering the focal distance of the lens apparatus focusing light on the photosensor further includes moving the lens apparatus focusing light on the photosensor a first distance 306 and, after capturing the second image data structure, moving the lens apparatus focusing light on the photosensor a second distance 310. In some embodiments, base distance 302, first distance 306 and second distance 310 are not equal. In some embodiments, the stopping the movement of the lens apparatus focusing the light on the photosensor before beginning capturing the second image data structure further includes stopping the movement of the lens apparatus focusing the light on the photosensor for an interval more than 1.5 times greater than but less than 2.5 times greater than the shutter interval. In some embodiments the second distance 310 is greater than the first distance 306.

FIG. 4 is a high-level logical flowchart of operations that may be used to implement refocusing via video capture according to some embodiments. A first image data structure is captured (block 400). A focal distance of a lens apparatus focusing light on a photosensor is altered (block 402). A second image data structure is captured (block 404). In some embodiments, the process returns to block 400 and repeats until a desired number of image data structures is captured. While embodiments are discussed herein with respect to capturing a first image data structure and a second structure, one of skill in the art will understand in light of having read the present disclosure that the invention is not so limited. Embodiments vary in terms of the number of image data structures that are captured, with the number of image data structures captured varying between from two to ‘n’ in various embodiments to suit the needs of particular users and the capabilities of particular hardware and software. In some embodiments, image data structures are continuously captured and focal distance alteration is performed while capture is in progress. More specifically, in some embodiments, refocusing is stopped during image data structure capture. In other embodiments, refocusing continues while image data structures are captured.

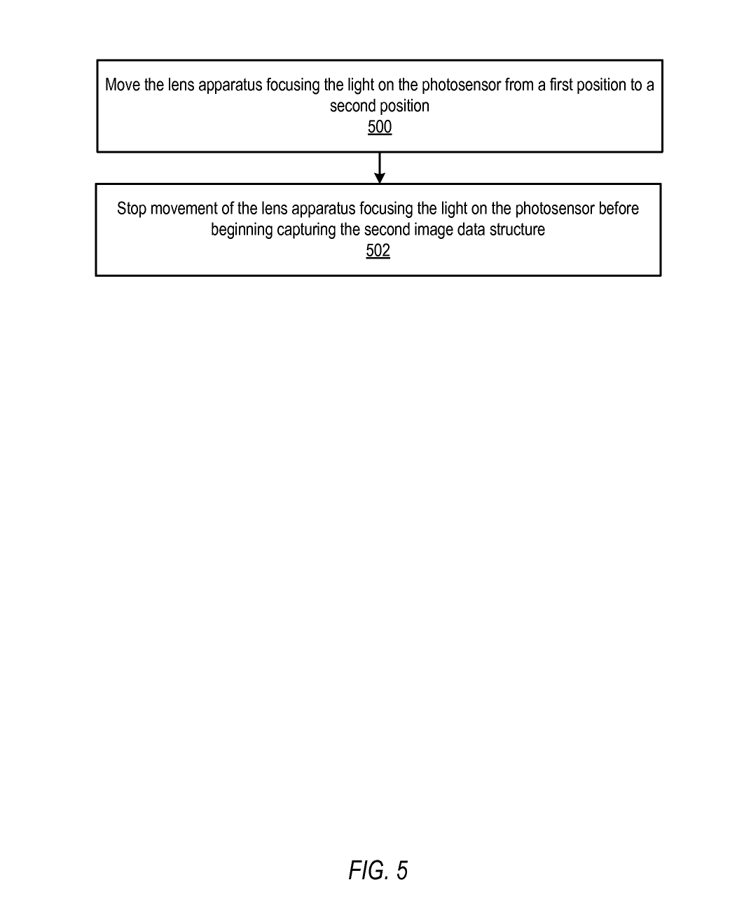

FIG. 5 is a high-level logical flowchart of operations that may be used to implement refocusing via video capture according to some embodiments. The lens apparatus focusing the light on the photosensor is moved from a first position to a second position (block 500). Movement of the lens apparatus focusing the light on the photosensor is stopped before beginning capturing the second image data structure (block 502).

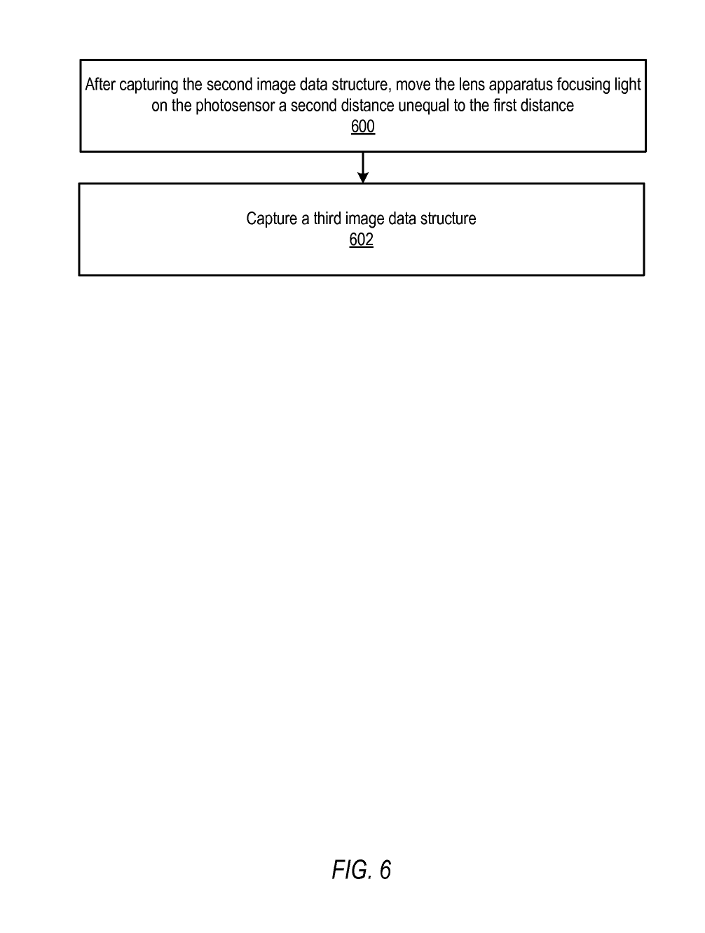

FIG. 6 is a high-level logical flowchart of operations that may be used to implement refocusing via video capture according to some embodiments. After capturing the second image data structure, the lens apparatus focusing light on the photosensor is moved a second distance unequal to the first distance (block 600). A third image data structure is captured (block 602).

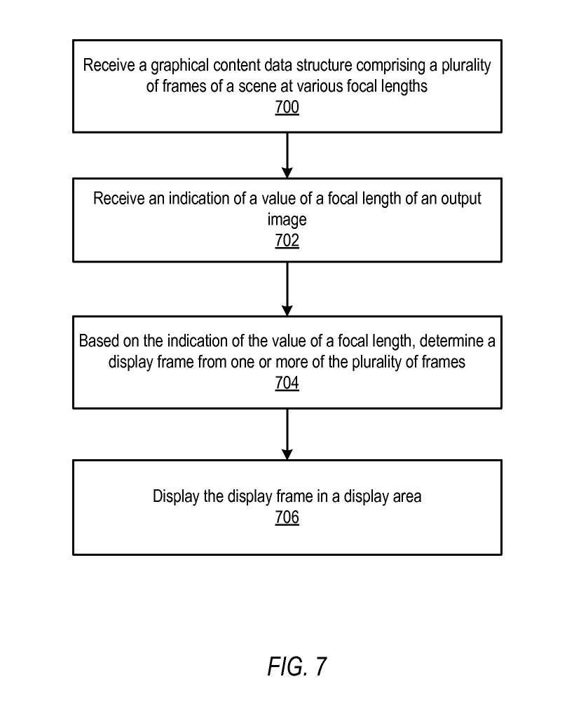

FIG. 7 is a high-level logical flowchart of operations that may be used to implement refocusing via video capture according to some embodiments. A graphical content data structure comprising a plurality of frames of a scene at various focal lengths is received (block 700). An indication of a value of a focal length of an output image is received (block 702). Based on the indication of the value of a focal length, a display frame from one or more of the plurality of frames is determined (block 704). The display frame is displayed in a display area (block 706).

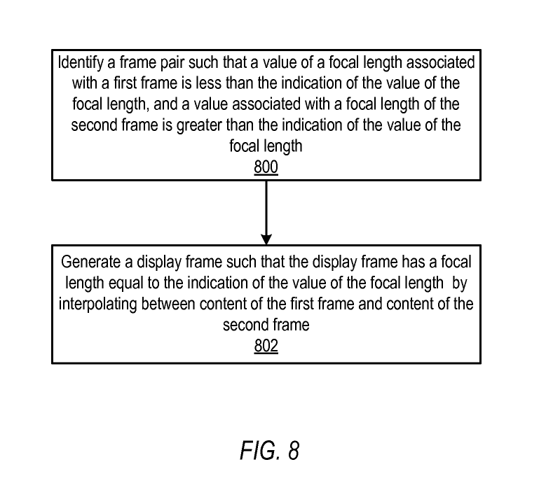

FIG. 8 is a high-level logical flowchart of operations that may be used to implement refocusing via video capture according to some embodiments. A frame pair such that a value of a focal length associated with a first frame is less than the indication of the value of the focal length and a value associated with a focal length of the second frame is greater than the indication of the value of the focal length are identified (block 800). A display frame such that the display frame has a focal length equal to the indication of the value of the focal length by interpolating between content of the first frame and content of the second frame (block 802).

### Example System

Embodiments of a video capture module and/or of the various video-based refocusing techniques as described herein may be executed on one or more computer systems, which may interact with various other devices. One such computer system is illustrated by FIG. 9. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a video capture module are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 9, memory 1020 may include program instructions 1025, configured to implement embodiments of a video capture module as described herein, and data storage 1035, comprising various data accessible by program instructions 1025. In one embodiment, program instructions 1025 may include software elements of embodiments of a video capture module as illustrated in the above Figures. Data storage 1035 may include data that may be used in embodiments. In other embodiments, other or different software elements and data may be included.

Those skilled in the art will appreciate that computer system 1000 is merely illustrative and is not intended to limit the scope of a video capture module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A method, comprising:
using one or more processors to perform
in response to an image capture request, capturing a multi-focus image data structure comprising a plurality of image data structures representing a scene, wherein
the capturing the plurality of image data structures further comprises
capturing a first image data structure,
altering a focal distance of a lens apparatus focusing light on a photosensor,
capturing a second image data structure, and
discarding at least one image captured during refocusing.

2. The method of claim 1, further comprising:
generating an image of the scene by interpolating the image of the scene from a plurality of image data structures, wherein the generating further comprises generating an image of the scene with a focal distance different from the focal distances of the image data structures.

3. The method of claim 1, further comprising:
generating an image of the scene by compositing the image of the scene from a plurality of image data structures, wherein the generating further comprises generating an image of the scene including regions having respective regional focal distances different from one another.

4. The method of claim 1, wherein the altering the focal distance of the lens apparatus focusing the light on the photosensor further comprises:
moving the lens apparatus focusing the light on the photosensor from a first position to a second position; and
stopping movement of the lens apparatus focusing the light on the photosensor before beginning capturing the second image data structure.

5. The method of claim 1, wherein the stopping the movement of the lens apparatus focusing the light on the photosensor before beginning capturing the second image data structure further comprises stopping the movement of the lens apparatus focusing the light on the photosensor for an interval more than 1.5 times greater than but less than 2.5 times greater than the shutter interval.

6. The method of claim 5, wherein the second distance is greater than the first distance.

7. The method of claim 1, wherein
the altering a focal distance of the lens apparatus focusing light on the photosensor further comprises moving the lens apparatus focusing light on the photosensor a first distance; and
the method further comprises
after capturing the second image data structure, moving the lens apparatus focusing light on the photosensor a second distance, wherein the first distance and the second distance are not equal, and
capturing a third image data structure.

8. A system, comprising:
at least one processor; and
a memory comprising program instructions, wherein the program instructions are executable by the at least one processor to:
in response to an image capture request, capture a multi-focus image data structure comprising a plurality of image data structures representing a scene, wherein
the program instructions executable by the at least one processor to capture the plurality of image data structures further comprise program instructions executable by the at least one processor to
capture a first image data structure,
alter a focal distance of a lens apparatus focusing light on a photosensor,
capture a second image data structure, and
discard at least one image captured during refocusing.

9. The system of claim 8, further comprising program instructions executable by the at least one processor to:
generate an image of the scene by interpolating the image of the scene from a plurality of image data structures, wherein the program instructions executable by the at least one processor to generate further comprise program instructions executable by the at least one processor to generate an image of the scene with a focal distance different from the focal distances of the image data structures.

10. The system of claim 8, further comprising program instructions executable by the at least one processor to:
generate an image of the scene by compositing the image of the scene from a plurality of image data structures, wherein the program instructions executable by the at least one processor to generate further comprise program instructions executable by the at least one processor to generate an image of the scene including regions having respective regional focal distances different from one another.

11. The system of claim 8, wherein the program instructions executable by the at least one processor to alter the focal distance of the lens apparatus focusing the light on the photosensor further comprise program instructions executable by the at least one processor to:
move the lens apparatus focusing the light on the photosensor from a first position to a second position; and
stop movement of the lens apparatus focusing the light on the photosensor before beginning capturing the second image data structure.

12. The system of claim 8, wherein the program instructions executable by the at least one processor to stop the movement of the lens apparatus focusing the light on the photosensor before beginning capturing the second image data structure further comprise program instructions executable by the at least one processor to stop the movement of the lens apparatus focusing the light on the photosensor for an interval more than 1.5 times greater than but less than 2.5 times greater than the shutter interval.

13. The system of claim 8, wherein
the program instructions executable by the at least one processor to alter a focal distance of the lens apparatus focusing light on the photosensor further comprise program instructions executable by the at least one processor to move the lens apparatus focusing light on the photosensor a first distance; and
the program instructions executable by the at least one processor further comprise program instructions executable by the at least one processor to:
after capturing the second image data structure, move the lens apparatus focusing light on the photosensor a second distance, wherein the first distance and the second distance are not equal, and
capture a third image data structure.

14. The system of claim 8, wherein the second distance is greater than the first distance.

15. A non-transitory computer-readable storage medium storing program instructions, wherein the program instructions are computer-executable to implement:
in response to an image capture request, capturing a multi-focus image data structure comprising a plurality of image data structures representing a scene, wherein
the capturing the plurality of image data structures further comprises
capturing a first image data structure,
altering a focal distance of a lens apparatus focusing light on a photosensor,
capturing a second image data structure, and
discarding at least one image captured during refocusing.

16. The non-transitory computer-readable storage medium of claim 15, further comprising:
program instructions computer-executable to implement generating an image of the scene by interpolating the image of the scene from a plurality of image data structures, wherein the program instructions computer-executable to implement the generating further comprise program instructions computer-executable to implement generating an image of the scene with a focal distance different from the focal distances of the image data structures.

17. The non-transitory computer-readable storage medium of claim 15, further comprising:
program instructions computer-executable to implement generating an image of the scene by compositing the image of the scene from a plurality of image data structures, wherein the program instructions computer-executable to implement the generating further comprise program instructions computer-executable to implement generating an image of the scene including regions having respective regional focal distances different from one another.

18. The non-transitory computer-readable storage medium of claim 15, wherein the program instructions computer-executable to implement altering the focal distance of the lens apparatus focusing the light on the photosensor further comprise program instructions computer-executable to implement:
moving the lens apparatus focusing the light on the photosensor from a first position to a second position; and
stopping movement of the lens apparatus focusing the light on the photosensor before beginning capturing the second image data structure.

19. The non-transitory computer-readable storage medium of claim 15, wherein the program instructions computer-executable to implement stopping the movement of the lens apparatus focusing the light on the photosensor before beginning capturing the second image data structure further comprise program instructions computer-executable to implement stopping the movement of the lens apparatus focusing the light on the photosensor for an interval more than 1.5 times greater than but less than 2.5 times greater than the shutter interval.

20. The non-transitory computer-readable storage medium of claim 15, wherein
the program instructions computer-executable to implement altering a focal distance of the lens apparatus focusing light on the photosensor further comprise program instructions computer-executable to implement moving the lens apparatus focusing light on the photosensor a first distance; and
the non-transitory computer-readable storage medium further comprises program instructions computer-executable to implement
after capturing the second image data structure, moving the lens apparatus focusing light on the photosensor a second distance, wherein the first distance and the second distance are not equal, and
capturing a third image data structure.
